(19) United States
(12) Patent Application Publication
(10) Pub. No.: US 2001/0018123 A1
(43) Pub. Date: Aug. 30, 2001

(54) Electromagnetic wave shielding device

(76) Inventors: Kenji Furumori, Osaka (JP); Shintarou Wada, Osaka (JP); Zenichi Ueda, Osaka (JP); Toshiyuki Yoshikawa, Osaka (JP)

Correspondence Address: SUGHRUE, MION, ZINN, MACPEAK & SEAS, PLLC, Suite 800, 2100 Pennsylvania Avenue, N. W., Washington, DC, 20037-3213, US

(21) Appl. No.: 09/770,231

(22) Filed: Jan. 29, 2001

(30) Foreign Application Priority Data
Jan. 28, 2000 (JP) 2000-19560
Jan. 28, 2000 (JP) 2000-19559
Jan. 31, 2000 (JP) 2000-21055

(51) Int. Cl. B32B 5/26; B32B 27/12

(52) U.S. Cl. 428/343; 442/381; 442/394

(57) ABSTRACT

An electromagnetic wave shielding device comprising an electroconductive material, a flexible material, and a pressure-sensitive adhesive layer that is or is to be applied to the electroconductive material through the flexible material. Also, disclosed are an electromagnetic wave shielding device for use in shielding a surface of body in which a cardiac pacemaker is embedded, wherein the shielding device is rectangular in shape and a shorter side and a longer side thereof have lengths (D_{S} and D_{L}, respectively) satisfying formula below:

about λ/4≦length (D_{S}) of shorter side≦about 3λ/4

about 2λ/5≦length (D_{L}) of longer side≦about 3λ/4

wherein λ represents a wavelength of electromagnetic wave to be shielded by the shielding device and a method of shielding an electromagnetic wave from a cardiac pacemaker comprising applying such an electromagnetic wave shielding device to a surface of body or underwear.

### BACKGROUND OF THE INVENTION

1. Field of the Invention

The present invention relates to an electromagnetic wave shielding device that shields electronic devices affected by magnetic waves and the like therefrom. More particularly, the present invention relates to an electromagnetic wave shielding device that protects medical devices implanted in the body such as a cardiac pacemaker from malfunctions caused by electromagnetic waves and the like. Moreover, the present invention relates to a method for shielding electronic devices, particularly medical devices, typically cardiac pacemakers from electromagnetic waves and the like.

2. Description of the Relaed Art

With a recent aggravation of electromagnetic environment, there have been increasing reports of malfunctions of various electronic devices and electronic medical devices. Accordingly, research has been under way to develop techniques for cutting the generation of unnecessary electromagnetic waves or for avoiding receiving them in many fields of industry. Under the circumstances, medical devices for therapy, in particular cardiac pacemakers are representatives of medical devices that are not allowed to cause malfunctions since such malfunctions will lead to immediate danger of life. Therefore, countermeasures for preventing malfunctions due to electromagnetic waves and the like from occurring are sought.

On the other hand, with the development of information or technetronized society, various office automation devices and communication devices have distributed rapidly and widely. For example, handy phones (also called movable phones or portable phones) distributed to so many people regardless of age and sex, and it is expected that an will come soon where every person brings with him or her one handy phone. Various research institutions have been investigating influences of electromagnetic waves, particularly those generated by handy phones on the human body and have made reports on the malfunctions of cardiac pacemakers caused by the electromagnetic waves from handy phones. Hence, the Japanese governmental authorities issued a guideline that a handy phone should not come within a distance of 22 cm from any cardiac pacemaker.

However, in recent social life, one cannot always avoid using elevators, trams and the like which are often full of people or walking in a congestion or crowd on the road or in buildings, so that in reality patients who have a cardiac pacemaker in the body always feel uneasy. On the other hand, with the change in food and life style, patients with adult disease have been increasing and naturally patients who have a cardiac pacemaker in the body have been increasing.

As described above, the influences of electromagnetic waves generated by electronic devices, in particular handy phones on cardiac pacemakers are very serious.

A cardiac pacemaker is connected with a pacemaker body with a pacemaker lead, through which the pacing and action potential of heart are detected when in operation. The malfunctions of a pacemaker due to electromagnetic wave noises occur when the lead portion and portion connecting the lead portion and the pacemaker body receive electromagnetic wave noises, which then are transmitted to electronic devices in the form of electric signal noises. In addition, since the action potential of heart is as low as several millivolts (mV), electromagnetic wave noises give a more severe influence on cardiac pacemakers than any other electronic devices.

Under the circumstances, as means for preventing malfunctions of cardiac pacemakers from occurring due to electromagnetic wave noises coming from outside, there have been proposed various shielding materials. For example, Published Unexamined Japanese Patent Application No. Hei 2-221402 discloses apron and clothes for shielding electromagnetic waves. Japanese Patent No. 2,850,954 (corresponding to Published Unexamined Japanese Patent Application No. Hei 10-52506) and Published Unexamined Japanese Patent Application No. Hei 11-244399 disclose the method of applying a pressure-sensitive adhesive sheet for shielding electromagnetic waves, comprising a cloth made of a metal-plated fiber having a pressure-sensitive adhesive layer directly laminated on one surface of the cloth on the skin or an underwear.

### SUMMARY OF THE INVENTION

The present invention provides the followings:

1) An electromagnetic wave shielding device comprising an electroconductive material, a flexible material, and a pressure-sensitive adhesive layer that is or is to be applied to the electroconductive material through the flexible material.

2) The electromagnetic wave shielding device as described in 1) above, wherein the electroconductive material is an electroconductive sheet and the flexible material is a flexible sheet.

3) The electromagnetic wave shielding device as described in 2) above, wherein the flexible sheet incorporates therein the electroconductive sheet and wherein at least a portion of the flexible sheet is provided with the pressure-sensitive adhesive layer.

4) The electromagnetic wave shielding device as described in 2) above, wherein the flexible sheet is provided with the electroconductive sheet on one surface thereof and the pressure-sensitive adhesive layer on the other surface thereof.

5) The electromagnetic wave shielding device as described in 1) above, wherein, wherein the electroconductive material is at least one selected from the group consisting of a metal foil, a plastic film deposited with a metal, a fabric made of a metal fiber, and a fabric coated with a metal.

6) The electromagnetic wave shielding device as described in 1) above, wherein the flexible sheet is air permeable.

7) The electromagnetic wave shielding device as described in 1) above, wherein the pressure-sensitive adhesive is provided in a pattern.

8) The electromagnetic wave shielding device as described in 1) above, wherein the shielding device is used by applying it to a surface of skin or underwear.

9) The electromagnetic wave shielding device as described in 2) above, wherein the electroconductive sheet is formed of cutting.

10) The electromagnetic wave shielding device as described in 4) above, wherein the flexible sheet is of a size greater than that of the electroconductive sheet and overruns out of peripheral portions of the electroconductive sheet.

11) The electromagnetic wave shielding device as described in 1) above, wherein the shielding device is rectangular in shape and a shorter side and a longer side thereof have lengths (D_{S} and D_{L}, respectively) satisfying formula below:

about λ/4≦length (D_{S}) of shorter side≦about 3λ/4

about 2λ/5≦length (D_{L}) of longer side≦about 3λ/4

wherein λ represents a wavelength of electromagnetic wave to be shielded by the shielding device.

12) The electromagnetic wave shielding device as described in 1) above, wherein the pressure-sensitive adhesive layer is in the form of a pressure-sensitive adhesive double coated tape comprising a substrate provided with a pressure-sensitive adhesive layer and a separator in order on each surface thereof.

13) An electromagnetic wave shielding device for use in shielding a surface of body in which a cardiac pacemaker is embedded, wherein the shielding device is rectangular in shape and a shorter side and a longer side thereof have lengths (D_{S} and D_{L}, respectively) satisfying formula below:

about λ/4≦length (D_{S}) of shorter side≦about 3λ/4

about 2λ/5≦length (D_{L}) of longer side≦about 3λ/4

wherein λ represents a wavelength of electromagnetic wave to be shielded by the shielding device.

14) The electromagnetic wave shielding device as described in 13) above, wherein the shielding device comprises a metal foil or woven fabric made of a metal-clad fiber.

15) The electromagnetic wave shielding device as described in 13) above, further comprising a pressure-sensitive adhesive layer for fixing the shielding device to a surface of body.

16) The electromagnetic wave shielding device as described in 13) above, wherein the shielding device suppresses electromagnetic wave noises from outside when applied to a surface of body.

17) The electromagnetic wave shielding device as described in 13) above, wherein the shielding device is used by applying it to a surface of skin or underwear.

18) An electromagnetic wave shielding device comprising a kit comprising a first element comprising an electroconductive material and a flexible material covering at least a portion of the electroconductive material and a second element comprising a pressure-sensitive adhesive double coated tape.

19) The electromagnetic wave shielding device as described in 18) above, wherein the pressure-sensitive adhesive double coated tape comprises a support made of a plastic sheet, nonwoven fabric or fabric, having on one surface thereof a pressure-sensitive adhesive layer, which comprises a pressure-sensitive adhesive having a low skin irritation, and a separator and on another surface thereof a pressure-sensitive adhesive layer, which comprises general-purpose pressure-sensitive adhesive, and a separator.

20) A method of shielding an electromagnetic wave from a cardiac pacemaker comprising applying an electromagnetic wave shielding device as claimed in claim 1 to a surface of body or underwear.

The above and other objects, effects, features and advantages of the present invention will become more apparent from the following detailed description of the invention referring to the attached drawings.

### BRIEF DESCRIPTION OF THE DRAWINGS

FIG. 1 is a schematic cross-sectional view illustrating the manner of using an electromagnetic wave shielding device according to an embodiment of the present invention.

FIG. 2 is a schematic cross-sectional view illustrating the manner of using an electromagnetic wave shielding device according to another embodiment of the present invention.

FIG. 3A is a schematic perspective view showing an electromagnetic wave shielding device of a rectangular shape according to an embodiment of the present invention.

FIG. 3B is a diagram showing the relationship between the sides of the electromagnetic wave shielding device shown in FIG. 3A and the wavelength of electromagnetic wave.

FIG. 4A is a schematic cross-sectional view showing an electromagnetic wave shielding device according to an embodiment of the present invention, having a separator.

FIG. 4B is a schematic cross-sectional view showing an electromagnetic wave shielding device according to an embodiment of the present invention, having a separator.

FIG. 5 is a schematic cross-sectional view showing an electromagnetic wave shielding device according to an embodiment of the present invention, having a separate pressure-sensitive adhesive layer.

FIG. 6 is a schematic diagram illustrating measurement of the shielding effect of an electromagnetic wave shielding device using an electromagnetic wave shielding device for a cardiac pacemaker according to one embodiment of the present invention.

### DETAILED DESRIPTION OF THE INVENTION

Hereinafter, the present invention will be described in detail with reference to the attached drawings.

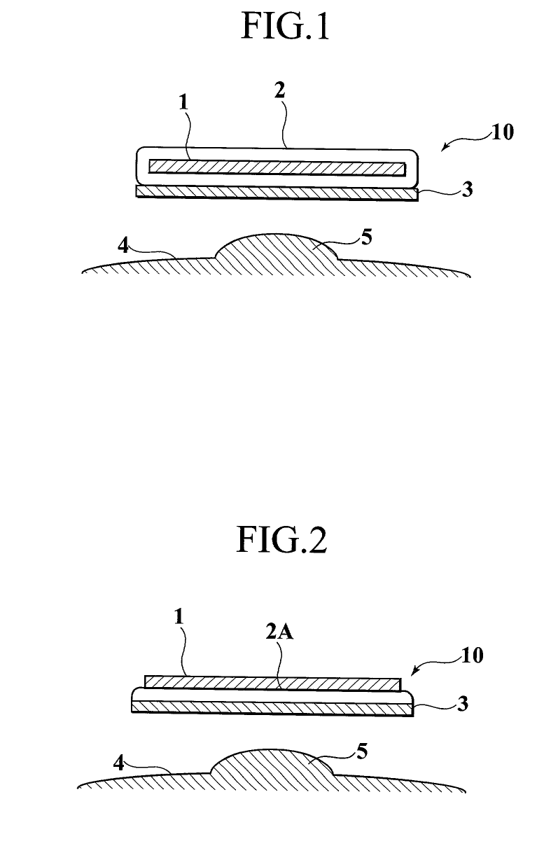

An electromagnetic wave shielding device 10 according to one embodiment of the present invention comprises an electroconductive sheet 1, an elastic sheet 2 having incorporated therein the electroconductive sheet 1, and a pressure-sensitive adhesive layer 3 provided on one surface of the elastic sheet 2 (FIG. 1). According to another embodiment, the electromagnetic wave shielding device of the present invention comprises the electroconductive sheet 1, an elastic sheet 2A laminated on the electroconductive sheet 1, and the pressure-sensitive adhesive layer 3 provided on a surface of the elastic sheet 2A other than the surface thereof on which the electroconductive sheet 1 is provided (FIG. 2). These electromagnetic wave shielding devices are applied to a skin 4 of a human body so that it covers the region where a cardiac pacemaker 5 is embedded (FIGS. 1 and 2).

The electromagnetic wave shielding device 10 includes an electroconductive material. More specifically, the electroconductive material preferably is a sheet-like material made of a matter having electroconductivity. The electroconductive material is not particularly limited and includes, for example, foils of metals such as copper, nickel, iron, silver, tin, and stainless steel, plastic films, e.g., films of various plastics such as polyethylene, polypropylene, polyethylene terephthalate, polyesters, polyethers, polyamides, polyvinyl chloride, ethylene/vinyl acetate copolymers, polyurethanes, rayon, acrylic resins, and silicone resins, that are laminated with a metal foil, such as a foil of any one of the above-described metals, metal-clad plastic films, i.e., plastic films having formed on the surface a metal layer by vacuum deposition, plating or the like means. Also, fabrics made of a fiber composed of a metal and metal-clad fabrics made of fabrics of a plastic fiber covered with a metal can be used. As the metals, those metals described above may be used. Where the electroconductive material is made of metal foils or metal-deposited plastic films, provision of cuts therein can make them flexible. Of the above materials, it is preferred to use metal-clad fabrics made of a plastic fiber from the viewpoint of flexibility.

In light of flexibility permitting its close contact with the skin, the electroconductive material has a thickness of usually from about 5 μm to about 500 μm, preferably from about 30 μm to about 200 μm. Furthermore, in the present invention, the relationship between the wavelength of the target electromagnetic wave to be shielded and the lengths of shorter and longer sides of the electroconductive material 1 is set to the specified one as described below.

The shielding performance required for an electromagnetic wave shielding device for cardiac pacemakers according to the present invention is desirably about 20 dB or more. This is because handy phones, one of the electronic devices that are most likely to give adverse influences on cardiac pacemakers must be used at a distance of more than 22 cm from any cardiac pacemaker according to the guideline issued by the Japanese governmental authorities.

The intensity of electric field of a cardiac pacemaker in this position (at a distance of more than 22 cm from a handy phone) is about 20 dB lower (about −20 dB) than that measured in the same position of the pacemaker but the handy phone has approached closest thereto. Therefore, if the electromagnetic wave noises are attenuated by about 20 dB with a shielding device in the position where a pacemaker is closest, the malfunctions of the pacemaker will be effectively prevented.

The electromagnetic wave shielding device of the present invention uses an electroconductive material having a sheet surface resistance of about 0.2 Ω/□ or less, preferably about 0.1 Ω/□ or less. With the electromagnetic wave shielding device of the present invention, the electromagnetic waves that are directly transmitted through the shielding device are attenuated by about 40 dB. Accordingly, the intensity of the electromagnetic waves coming round about the peripheral portions of the shielding device affects the pacemaker to cause malfunctions.

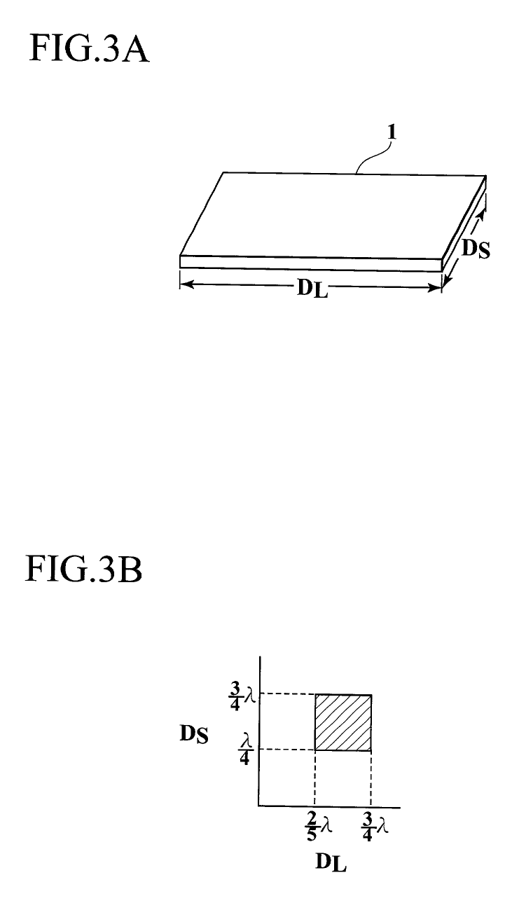

Therefore, in the present invention, it is desirable that the electromagnetic wave that transmits round around peripheral portions of the electromagnetic wave shielding device to reach the cardiac pacemaker will have a decrease in intensity of about −20 dB as compared with the intensity as measured in the same position of the pacemaker but the handy phone has approached closest thereto. In this regard, where the electromagnetic wave shielding device of the present invention is of a rectangular form, the rectangular electromagnetic wave shielding device has the following size. That is, assuming the wavelength of the electromagnetic wave is λ, the length (D_{S}) of its shorter side is about λ/4 or more and about 3λ/4 or less and the length (D_{L}) of its longer side has a length of about 2λ/5 and about 3λ/4 or less (FIG. 3). Where the shorter and longer sides are more than about 3λ/4, the shielding performance of the shielding device will be saturated and no further increase in shielding performance is expected so that in the present invention it is desirable that the length of each side should not exceed about 3λ/4 in order to realize a decrease in skin irritation.

Furthermore, in order to exhibit sufficient electromagnetic wave shielding property, the size of the electroconductive material used in the present invention is of a size of usually about 10 cm×about 10 cm (about 100 cm²) or more, preferably about 15 cm×about 15 cm (about 225 cm²) or more. In view of the size of the site of the body (breast) to which the electromagnetic wave shielding device is applied, the size of the electroconductive material is preferably about 20 cm×about 20 cm (about 400 cm²) or less. The shape of the electroconductive material is not particularly limited and may be changed freely depending on the shape or contour of the cardiac pacemaker.

Moreover, where the electroconductive material is not used as is but is laminated on one surface of a backing sheet or incorporated in a bag-like backing sheet, the electromagnetic wave shielding device will not contact the surface of the body sufficiently closely if the flexibility of the electroconductive material itself is hindered by the backing sheet. In such a case, the electromagnetic wave shielding device may be imparted with flexibility by use of a flexible backing sheet (hereinafter, sometimes referred to simply as “flexible sheet”).

Alternatively, where an electroconductive sheet having no or insufficient flexibility, such as one having a non-flexible plastic film as a base, is used, the electroconductive sheet may be imparted with flexibility by providing therein slit-like or cross-like cutting.

Where a backing sheet is used, it is preferably one that has sufficient flexibility for allowing the electromagnetic wave shielding device for cardiac pacemakers of the present invention to follow the movement of the body when it is applied to the surface of the body. The thickness of the backing sheet is usually about 20 μm to about 1,000 μm, preferably about 30 μm to about 500 μm. Specific examples of the material for preparing the backing sheet include polyesters, polypropylene, polyethylene, polyethers, polyamides, polyvinyl chloride, ethylene/vinyl acetate copolymers, polyurethanes, rayon, cotton, silk, hemp, etc.

The backing sheet materials may be molded into a film or sheet, or fabric such as a woven fabric or a nonwoven fabric. Where the material itself has poor flexibility, it may be imparted with flexibility by molding it into a fabric such as woven fabric or nonwoven fabric. Of these, a preferred flexible sheet is a fabric made of a plastic such as polyurethane nonwoven fabric.

It is further preferred that the backing sheet be imparted with air permeability so as not to avoid nonbreathing or the like when it is applied to the body surface. The degree of air permeability is preferably about 300 g/m²·24 hours or more and more preferably about 500 g/m²·24 hours or more.

Lamination of the electroconductive material onto a surface of the backing sheet may be realized by various methods such as a method of binding them with a pressure-sensitive adhesive or an adhesive, a method of fixing them with a pressure-sensitive adhesive double coated tape, a method of overlapping them with a pressure-sensitive adhesive sheet, a method of sewing them together with a thread and so on. Where they are bound with a pressure-sensitive adhesive or an adhesive, the pressure-sensitive adhesive or the adhesive do not have to be coated on the entire surface of the electroconductive material and/or backing sheet but it may be coated on a part thereof for laminating them since it is only necessary that the backing sheet and the electroconductive material will not separate from each other.

Where the electromagnetic wave shielding device of the present invention is used by a patient who could suffer from allergy to metals as a result of contact of the skin with the metal in the edge portion of the electroconductive material, the electroconductive material can be incorporated in the backing sheet. In this case, the electroconductive material may be incorporated in the flexible sheet by molding the flexible sheet into a bag-like form and placing the electroconductive material therein. Also, the electroconductive material may be incorporated in the flexible sheet by sandwiching the electroconductive material with two flexible sheets and bonding the peripheral portions thereof with an adhesive or by heat-bonding.

Where the electroconductive material is laminated on a surface of the backing sheet, it is preferred that he backing sheet be greater in size than the electroconductive material and laminated such that it overruns out of the peripheral portions of the electroconductive material. In this case, it is preferred that the backing sheet be laminated such that it overruns out of the peripheral portions of the electroconductive material by from about 0.1 cm to about 3 cm, preferably from about 0.3 cm to about 2 cm. If the overrun is less than about 0.1 cm, the contact of the electroconductive material on the surface of the skin cannot be prevented sufficiently whereas if the overrun exceeds about 3 cm, the handling property of the electromagnetic wave shielding device tends to be deteriorated.

The method of applying the electromagnetic wave shielding device for cardiac pacemaker of the present invention to the surface of the body includes a method of fixing them with a commercially available medical pressure-sensitive tape, a method of providing a pressure-sensitive layer on the electroconductive material and applying the shielding device through the pressure-sensitive adhesive layer, and the like. When the electromagnetic wave shielding device on the surface of the body or cloths such as underwear, it is important that the peripheral portions of the shielding device be fixed such that they should not come up from the surface of the body.

Furthermore, it is preferred from the viewpoint of electromagnetic wave shielding property that the electromagnetic wave shielding device of the present invention be applied such that the longer side of rectangle of the shielding device is along the direction of the height of the human body. Application of the electromagnetic wave shielding device in such a fashion effectively decreases the intensity of the electromagnetic wave that comes round about the peripheral portions of the shielding device. Incidentally, the antenna of a handy phone that is one of the worst sources of electromagnetic wave noises is vertical or along the direction of height of a person and the antenna approaches the person who has a cardiac pacemaker in the body.

The electromagnetic wave shielding device of the present invention having the above structure can be applied to the surface of body or cloths (for example underwear) upon use.

The pressure-sensitive adhesive layer used when applying the electromagnetic wave shielding device of the present invention to the surface of body or cloths is provided on one surface of the electroconductive material or backing sheet or flexible sheet, that is, on the side of the object to which the electromagnetic wave shielding device is to be applied. The pressure-sensitive adhesive which can be used in the present invention includes those known in the art as medical pressure-sensitive adhesives, for example, acrylic pressure-sensitive adhesives, silicone pressure-sensitive adhesives, vinyl ether pressure-sensitive adhesives, synthetic rubber pressure-sensitive adhesives, semi-synthetic rubber pressure-sensitive adhesives, etc. The thickness of the pressure-sensitive adhesive layer is usually from about 20 μm to about 80 μm.

The pressure-sensitive layer may be formed on the entire are of one of the surface of the electroconductive material or backing sheet. However, it may be formed preferably by pattern coating in order not to decrease the air permeability where the electroconductive material or backing sheet is air permeable or to reduce skin irritation where the shielding device is applied to the surface of body. The pattern coating may be carried out by freely selecting one or more desired patterns such as striation, dots, grids, and the like. The pattern coating may be formed only on the peripheral portions of the backing sheet.

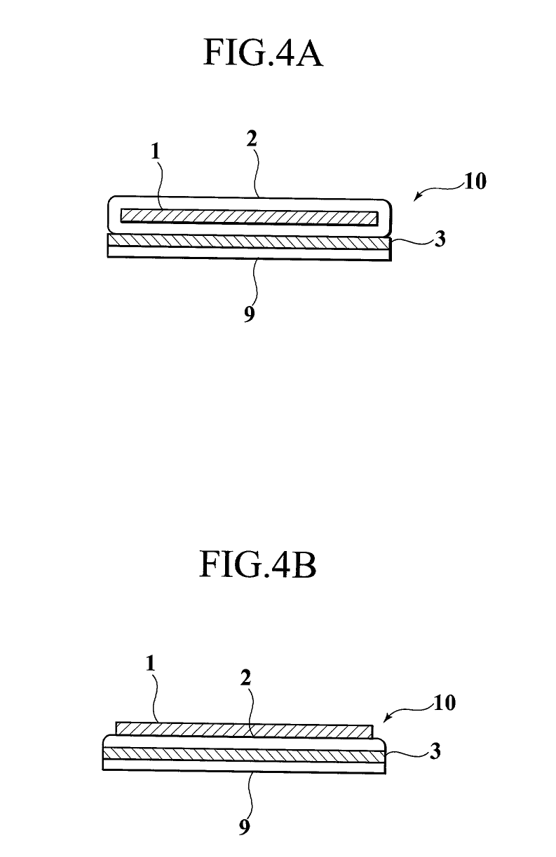

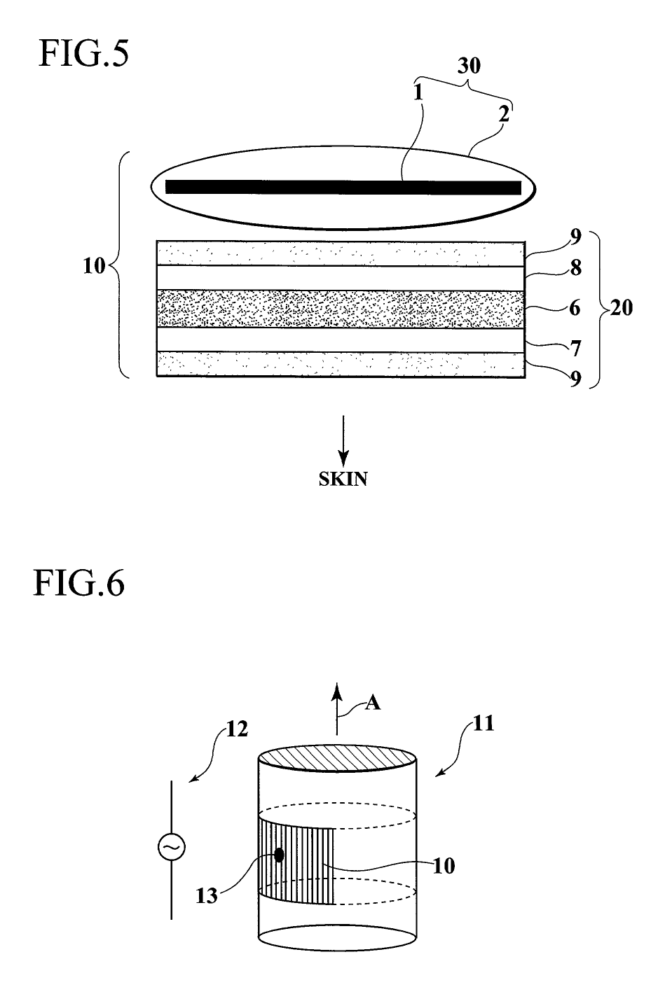

It is preferred that until use, a separator 9 be provided on the above-described adhesive layer of the electromagnetic wave shielding device in order to protect the pressure-sensitive adhesive layer as shown in as shown in FIGS. 4A and 4B. For example, the separator may comprise as a plastic film such as polyethylene film or a polypropylene film, paper, a laminate film such as paper laminated with a plastic film such as a polypropylene film on one or both surfaces thereof as a substrate, which is coated with a release agent such as a silicone resin or a fluororesin, or a long chain aliphatic organic substances such as a long chain alkane.

In the present invention, the pressure-sensitive adhesive layer may be formed directly on the electroconductive material or backing sheet (flexible sheet). However, the pressure-sensitive adhesive layer may be formed indirectly by preparing in advance a so-called pressure-sensitive adhesive double coated tape 20 and pressing the pressure-sensitive adhesive layer 8 to one surface of the electroconductive material 1 or backing sheet or flexible sheet 2 or 2A after removal of the separator 9 when in use. As shown in FIG. 4, the tape 20 may comprise a support 6 made of a plastic sheet, nonwoven fabric or fabric, or the like, having on one surface thereof (on the side at which the tape is applied to the skin) a pressure-sensitive adhesive layer 7, which comprises a pressure-sensitive adhesive having a low skin irritation, and a separator 9 such as release coated paper and on another surface thereof a pressure-sensitive adhesive layer 8, which comprises general-purpose pressure-sensitive adhesive, and a separator 9 such as release coated paper. In other words, the electromagnetic wave shielding device may be provided as a kit that comprises a first element (shielding composite) 30 comprising an electroconductive material 1 and a flexible material 2 covering at least a portion of the electroconductive material 1 and a second element 20 comprising a pressure-sensitive adhesive double coated tape. The pressure-sensitive adhesive double-coated tape 20 may be of the same structure as described above.

In the above cases, it is preferred to use a pressure-sensitive adhesive double coated tape including a fabric as a support so that the tape should not inhibit the flexibility and/or air permeability of electroconductive material and flexible material. Also, it is preferred to use pressure-sensitive adhesive mild to the skin, i.e., having low skin irritation as the pressure-sensitive adhesive referred to above. Use of such pressure-sensitive adhesive mild to the skin makes it possible to use the electromagnetic wave shielding device repeatedly. More particularly, the shielding composite can be used repeatedly by separating it from the pressure-sensitive adhesive double coated tape 20 after use and then bonding it to the pressure-sensitive adhesive layer of another or fresh pressure-sensitive adhesive double coated tape after removing the separator and then applying the shielding device to a surface of body through the other pressure-sensitive adhesive layer having low skin irritation after removing the separator. In this manner, the electromagnetic shielding device can be used in plural times.

### EXAMPLES

Hereinafter, the electromagnetic wave shielding device of the present invention will be described in greater detail by examples and comparative examples. The present invention should not be construed as being limited to the examples and various changes and modifications may be made without departing the spirit and scope of the present invention.

The properties of the electromagnetic wave shielding device of the present invention were evaluated as described below.

<Electromagnetic Wave Shielding Property>

For evaluation was used a model of human body made of aqueous gel composed mainly of polyacrylic acid, in which a cardiac pacemaker was embedded 2 cm below the surface of the model. Then, an electromagnetic wave shielding pressure-sensitive adhesive sheet was applied to a surface of the model such that it could cover the pacemaker (FIG. 6).

A handy phone (800 MHz) was placed and moved closer to a position at a distance of about 2 cm from the electromagnetic wave shielding pressure-sensitive adhesive sheet. The pacemaker was checked if it caused any malfunction.

Evaluation was made based on the following criteria.

∘: No pacing malfunction was observed.

×: Pacing malfunction was observed.

<Skin Irritation>

A pressure-sensitive adhesive sheet for shielding electromagnetic waves was applied to a skin surface in the heart portion of a normal person continuously for 8 hours and then peeled off. The day next, another pressure-sensitive adhesive sheet of the same type was applied to the same spot on the skin surface and then peeled off in the same manner as above. This procedure was repeated for 1 week. Thereafter, the conditions of the skin surface on which the pressure-sensitive adhesive sheet was applied were judged based on the following criteria for judgment.

∘: Substantially no redness was observed on the skin surface.

Δ: Redness was observed on a part of the skin surface.

×: A part of the skin surface was peeled and strong skin irritation such as blisters appeared.

### Example 1

90 parts by weight of 2-ethylhexyl acrylate and 10 parts by weight of 2-hydroxyethyl acrylate were copolymerized in an inert gas atmosphere in ethyl acetate as a polymerization solvent to obtain a solution of an acrylic pressure-sensitive adhesive.

Then, 60 parts by weight of sorbitan trioleate and 0.16 parts by weight of trifunctional isocyanate (trade name: Coronate L, produced by Nippon Polyurethane Co., Ltd.) as a crosslinking agent per 100 parts by weight of the solids content of the obtained pressure-sensitive adhesive solution were blended with the acrylic pressure-sensitive adhesive solution. The resulting mixture was coated on a release treated surface of a separator and dried to form a pressure-sensitive adhesive layer of 40 μm thick.

In the same manner as in above, another pressure-sensitive adhesive layer was formed on a separator and the obtained pressure-sensitive layers were applied to both surfaces of a nonwoven fabric made of polyester (trade name: Sontara 8010, produced by DuPont Corp., basis weight: 45 g/m², 370 μm thick) to prepare a pressure-sensitive adhesive double coated tape. This was warmed at 60° C. for 3 days to effect crosslinking treatment.

Next, a woven fabric made of a metal-coated fiber (trade name: Sui-10-70, an electroconductive fabric produced by Seren Corp., metal: copper and tin, specific surface resistance: 0.1 Ω/□, 100 μm thick, 15 cm×15 cm square) was placed in a bag made of a polyurethane nonwoven fabric (trade name: Espansione, produced by Kanebo Corp., basis weight: 75 g/m², 300 μm thick, 17 cm×17 cm square) so that the woven fabric could be incorporated in the nonwoven fabric.

Finally, on one surface of the above-described bag was applied the above-described pressure-sensitive adhesive double coated tape to form a pressure-sensitive adhesive sheet for shielding electromagnetic waves as shown in FIG. 1.

### Example 2

An electromagnetic wave shielding device as shown in FIG. 2 was prepared in the same manner as in Example 1 except that a woven fabric made of a metal-coated fiber (trade name: Sui-10-70, an electroconductive fabric produced by Seren Corp., metal: copper and tin, specific surface resistance: 0.1 Ω/□, 100 μm thick, 15 cm×15 cm square) was laminated on one surface of a polyurethane nonwoven fabric (trade name: Espansione, produced by Kanebo Corp., basis weight: 75 g/m², 300 μm thick, 17 cm×17 cm square) with the pressure-sensitive adhesive double coated tape as shown in FIG. 2.

### Comparative Example 1

The acrylic pressure-sensitive adhesive layer of 40 μm thick prepared in Example 1 was formed on one surface of the same woven fabric made of a metal-coated fiber as used in Example 1 by direct transfer and the product was cut to 15 cm×15 cm square to prepare an electromagnetic wave shielding device.

The electromagnetic wave shielding device samples prepared as described above were evaluated for electromagnetic wave shielding property and skin irritation upon actual use based on the above-described criteria. The results obtained are shown in Table 1.

TABLE 1

| | Electromagnetic | |
|---|---|---|
| | Wave Shielding | Skin |
| | Property | Irritation |
| Example 1 | ◯ | ◯ |
| Example 2 | ◯ | ◯ |
| Comparative | ◯ | X |
| Example 1 | | |

### Examples 3 to 9 and Comparative Examples 2 to 4

As the electroconductive material in an electromagnetic wave shielding device, a 100 μm-thick nonwoven fabric made of polyethylene terephthalate, plated with copper and nickel were used. The nonwoven fabric sheet had a sheet resistance of 0.05 Ω/□. Examination of the shielding property of the nonwoven sheets by the KEC method (KEC: Kansai Electronics Promotion Association) revealed that they had a shielding effect of 70 dB or more in a frequency range of from 10 MHz to 1 GHz.

The electroconductive material composed of nonwoven fabric plated with a metal was cut to rectangular pieces of various sizes as shown in Tables 2 and 3. There were used as electromagnetic wave shielding devices for cardiac pacemakers and their shielding effect was measured using an evaluation device as shown in FIG. 6.

The evaluation device shown in FIG. 6 is a human body model 11 made of a hydrated gel composed of agar, polyethylene powder and saline having a size of 8.9 cm in shorter axis and 14.2 cm in a longer axis and having an elliptic cylindrical cross-section. The human body model 11 was adjusted to have a relative dielectric constant of 35.8 and an electroconductivity of 0.6 S/m corresponding to about ⅔ times the electric constants of human muscle.

As sown in FIG. 6, at a position of 3 cm ahead of the human body model 11 was placed a dipole antenna 12 for transmission and electric signals of 800 MHz were applied thereto from an electric transmitter (not shown) to cause emission of electromagnetic waves from the transmitting antenna 12.

On the other hand, at a position opposite to the transmitting antenna 12 and 1 cm deep in the inside of the human body model 11 was placed a receiving antenna 13. Then the prepared electromagnetic wave shielding device was applied to a surface of the human body model 11 so that the receiving antenna 13 was placed in the central position of the electromagnetic wave shielding device 10. The shielding effect (SE) of the electromagnetic wave shielding device was calculated from a receiving electric field intensity E without application of any electromagnetic wave shielding device and a receiving electric field intensity E₀ when an electromagnetic wave shielding device was applied according to the following equation.

SE(dB)=−20·log(E/E₀)

The results obtained are shown in Table 2. In Table 2, the term “Vertical” in the column of “Size of Shielding device” means that the side of the shielding device is vertical (up down in FIG. 6), i.e., along the direction of height of the human body model 11 as indicated by arrow A in FIG. 6. The term “Horizontal” means that the side of the shielding device is horizontal (right to left in FIG. 6), i.e., at right angles to the direction of height of the human body model. This is true also in Table 3 hereinbelow.

The skin irritation was evaluated based on the following criteria for evaluation.

∘: No redness was observed on the skin surface after application for 8 hours.

×: Some redness was observed on the skin surface after application for 8 hours.

TABLE 2

| | | | Shielding | |
|---|---|---|---|---|
| | Size of Shielding | | Effect | |
| 800 MHz | device | | (SE) | Skin |
| λ = 37.5 cm | Vertical | Horizontal | (d B) | Irritation |
| Comparative | λ/4 | λ/4 | 11 | ◯ |
| Example 2 | | | | |
| Comparative | λ/4 | 2λ/5 | 13 | ◯ |
| Example 3 | | | | |
| Example 1 | 2λ/5 | 2λ/5 | 20 | ◯ |
| Example 2 | 2λ/5 | 2λ/5 | 25 | ◯ |
| Example 3 | λ/2 | λ/4 | 27 | ◯ |
| Example 4 | λ2 | 2λ/5 | 34 | ◯ |
| Example 5 | 3λ/4 | λ/2 | 39 | ◯ |
| Example 6 | λ | λ/2 | 48 | ◯ |
| Example 7 | λ/4 | λ/2 | 50 | ◯ |
| Comparative | λ | λ | 60 | X |
| Example 4 | | | | |

### Examples 10 to 16 and Comparative Examples 5 and 6

In the above examples and comparative examples, evaluation of shielding property and skin irritation was made in the same manner as in Examples 1 to 9 and Comparative Examples 1 and 2 except that electric signals of a frequency of 1.5 GHz were applied from the transmitter to the receiving antenna. The results obtained are shown in Table 3 below.

TABLE 3

| | | | Shielding |
|---|---|---|---|
| | Size of Shielding | | Effect |
| 800 MHz | device | | (SE) |
| λ = 37.5 cm | Vertical | Horizontal | (d B) |
| Comparative | λ/4 | λ/4 | 13 |
| Example 5 | | | |
| Comparative | λ/4 | 2λ/5 | 16 |
| Example 6 | | | |
| Example 8 | 2λ/5 | λ/4 | 21 |
| Example 9 | 2λ/5 | 2λ/5 | 25 |
| Example 10 | λ/2 | λ/4 | 26 |
| Example 11 | λ/2 | 2λ/5 | 32 |
| Example 12 | 3λ/4 | λ/2 | 33 |
| Example 13 | λ | λ/2 | 44 |
| Example 14 | λ/4 | λ/2 | 46 |

The electromagnetic wave shielding device for cardiac pacemakers according to the present invention having the above structure is less expensive and can be used more simply than conventional apron and clothes for shielding electromagnetic waves so that shielding can be ensured. If a handy phone is placed just above the body in close contact therewith, it will cause no malfunction of the cardiac pacemaker. The electromagnetic wave shielding device of the present invention has low skin irritation so that it can be used without uneasy feeling when applied for a long time. Therefore, the electromagnetic wave shielding device of the present invention can be used in daily life of persons who have a cardiac pacemaker in the body without anxiety.

The invention may be embodied in other specific forms without departing from the spirit or essential characteristics thereof. Therefore, the present embodiment is to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An electromagnetic wave shielding device comprising an electroconductive material, a flexible material, and a pressure-sensitive adhesive layer that is or is to be applied to the electroconductive material through the flexible material.

2. The electromagnetic wave shielding device as claimed in claim 1, wherein the electroconductive material is an electroconductive sheet and the flexible material is a flexible sheet.

3. The electromagnetic wave shielding device as claimed in claim 2, wherein the flexible sheet incorporates therein the electroconductive sheet and wherein at least a portion of the flexible sheet is provided with the pressure-sensitive adhesive layer.

4. The electromagnetic wave shielding device as claimed in claim 2, wherein the flexible sheet is provided with the electroconductive sheet on one surface thereof and the pressure-sensitive adhesive layer on the other surface thereof.

5. The electromagnetic wave shielding device as claimed in claim 1, wherein, wherein the electroconductive material is at least one selected from the group consisting of a metal foil, a plastic film deposited with a metal, a fabric made of a metal fiber, and a fabric coated with a metal.

6. The electromagnetic wave shielding device as claimed in claim 1, wherein the flexible sheet is air permeable.

7. The electromagnetic wave shielding device as claimed in claim 1, wherein the pressure-sensitive adhesive is provided in a pattern.

8. The electromagnetic wave shielding device as claimed in claim 1, wherein the shielding device is used by applying it to a surface of skin or underwear.

9. The electromagnetic wave shielding device as claimed in claim 2, wherein the electroconductive sheet is formed of cutting.

10. The electromagnetic wave shielding device as claimed in claim 4, wherein the flexible sheet is of a size greater than that of the electroconductive sheet and overruns out of peripheral portions of the electroconductive sheet.

11. The electromagnetic wave shielding device as claimed in claim 1, wherein the shielding device is rectangular in shape and a shorter side and a longer side thereof have lengths (D_{S} and D_{L}, respectively) satisfying formula below:
about λ/4≦length (D_{S}) of shorter side≦about 3λ/4
about 2λ/5≦length (D_{L}) of longer side≦about 3λ/4
wherein λ represents a wavelength of electromagnetic wave to be shielded by the shielding device.

12. The electromagnetic wave shielding device as claimed in claim 1, wherein the pressure-sensitive adhesive layer is in the form of a pressure-sensitive adhesive double coated tape comprising a substrate provided with a pressure-sensitive adhesive layer and a separator in order on each surface thereof.

13. An electromagnetic wave shielding device for use in shielding a surface of body in which a cardiac pacemaker is embedded, wherein the shielding device is rectangular in shape and a shorter side and a longer side thereof have lengths (D_{S} and D_{L}, respectively) satisfying formula below:
about λ/4≦length (D_{S}) of shorter side≦about 3λ/4
about 2λ/5≦length (D_{L}) of longer side≦about 3λ/4
wherein λ represents a wavelength of electromagnetic wave to be shielded by the shielding device.

14. The electromagnetic wave shielding device as claimed in claim 13, wherein the shielding device comprises a metal foil or woven fabric made of a metal-clad fiber.

15. The electromagnetic wave shielding device as claimed in claim 13, further comprising a pressure-sensitive adhesive layer for fixing the shielding device to a surface of body.

16. The electromagnetic wave shielding device as claimed in claim 13, wherein the shielding device suppresses electromagnetic wave noises from outside when applied to a surface of body.

17. The electromagnetic wave shielding device as claimed in claim 13, wherein the shielding device is used by applying it to a surface of skin or underwear.

18. An electromagnetic wave shielding device comprising a kit comprising a first element comprising an electroconductive material and a flexible material covering at least a portion of the electroconductive material and a second element comprising a pressure-sensitive adhesive double coated tape.

19. The electromagnetic wave shielding device as claimed in claim 18, wherein the pressure-sensitive adhesive double coated tape comprises a support made of a plastic sheet, nonwoven fabric or fabric, having on one surface thereof a pressure-sensitive adhesive layer, which comprises a pressure-sensitive adhesive having a low skin irritation, and a separator and on another surface thereof a pressure-sensitive adhesive layer, which comprises general-purpose pressure-sensitive adhesive, and a separator.

20. A method of shielding an electromagnetic wave from a cardiac pacemaker comprising applying an electromagnetic wave shielding device as claimed in claim 1 to a surface of body or underwear.
